(19) United States
(12) Patent Application Publication
(10) Pub. No.: US 2011/0316782 A1
(43) Pub. Date: Dec. 29, 2011

(54) OPTICAL MOUSE WITH LIGHT SOURCE AND LIGHT SOURCE SWITCHING METHOD THEREOF

(75) Inventors: PING-YANG CHUANG, Tu-Cheng (TW); YING-CHUAN YU, Tu-Cheng (TW)

(73) Assignee: HON HAI PRECISION INDUSTRY CO., LTD., Tu-Cheng (TW)

(21) Appl. No.: 12/949,809

(22) Filed: Nov. 19, 2010

(30) Foreign Application Priority Data
Jun. 28, 2010 (TW) 99120991

(51) Int. Cl. G06F 3/033

(52) U.S. Cl. 345/166

(57) ABSTRACT

An optical mouse includes an optical sensor, a number of different light sources, a light source switching module, and a controller. The controller determines the intensity of the reflected light sensed by the optical sensor when any of the light sources is turned on. If the determined intensity is less than a predetermined value, the controller directs the light source switching module to turn off a currently turned on light source and turn on another one of the light sources in sequence. A related light source switching method is also provided.

### BACKGROUND

1. Technical Field

The present disclosure relates to computer peripherals and, particularly, to an optical mouse with a number of light sources and a light source switching method thereof.

2. Description of Related Art

A standard optical mouse usually includes a single light source, for example an LED. Light of the light source is reflected by a support surface, and the reflected light is examined to control a displayed cursor. While being operated on different support surfaces, the reflected light may be different, thus the mouse may fail while being operated on a support surface that the light is not reflected adequately.

### BRIEF DESCRIPTION OF THE DRAWINGS

The components of the drawings are not necessarily drawn to scale, the emphasis instead being placed upon clearly illustrating the principles of an optical mouse with light sources and a light source switching method thereof. Moreover, in the drawings, like reference numerals designate corresponding parts throughout several views.

FIG. 1 is a block diagram of an optical mouse with light sources in accordance with an exemplary embodiment.

FIG. 2 is a flowchart of a light source switching method in accordance with an exemplary embodiment.

### DETAILED DESCRIPTION

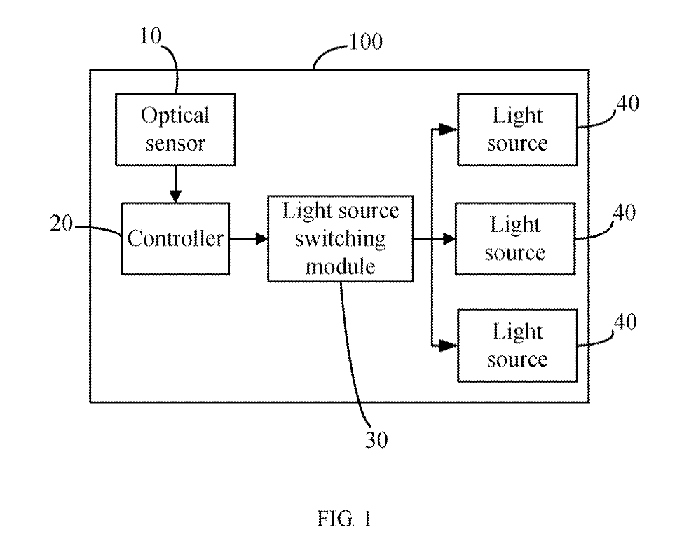

Referring to FIG. 1, an embodiment of an optical mouse 100 is illustrated. The optical mouse 100 includes an optical sensor 10, a controller 20, a light source switching module 30, and a number of different light sources 40. In this embodiment, the light sources 40 emit visible light with different wavelengths. In an alternative embodiment, one light source 40 emits infrared, and the remaining of the light sources 40 emits visible light with different wavelengths. The light source switching module 30 is directed by the controller 20 to selectively turn on or turn off the light sources 40.

The controller 20 determines the intensity of the reflected light sensed by the optical sensor 10 when any one of the light sources 40 is turned on. The light of one light source 40 is reflected more adequately by a support surface, the intensity of the reflected light sensed by the optical sensor 10 is greater, and the mouse 100 can control a displayed cursor more precisely. If the determined intensity is less than a predetermined value, the controller 20 directs the light source switching module 30 to turn off the currently turned on light source 40 and turn on another one of the light sources 40 in sequence. If the determined intensity is equal to or greater than the predetermined value, the controller 20 determines that the currently turned on light source 40 is suitable, and the mouse 100 can control a displayed cursor precisely. Hence, the currently turned on light source 40 is kept in an on state. If the controller 20 determines that the determined intensity is less than the predetermined value when all of the light sources 40 have been turned on in sequence, the controller 20 directs the light source switching module 30 to turn on one of the light sources 40 which light is reflected more adequately than any of the remaining of the light sources 40. That is, the mouse 100 can control the displayed cursor better when the one of the light sources 40 is turned on. With such configuration, the mouse 100 can automatically select a suitable light source 40 according to the intensity of the reflected light sensed by the optical sensor 10, thus the mouse 100 can be used on different support surfaces to control the displayed cursor precisely.

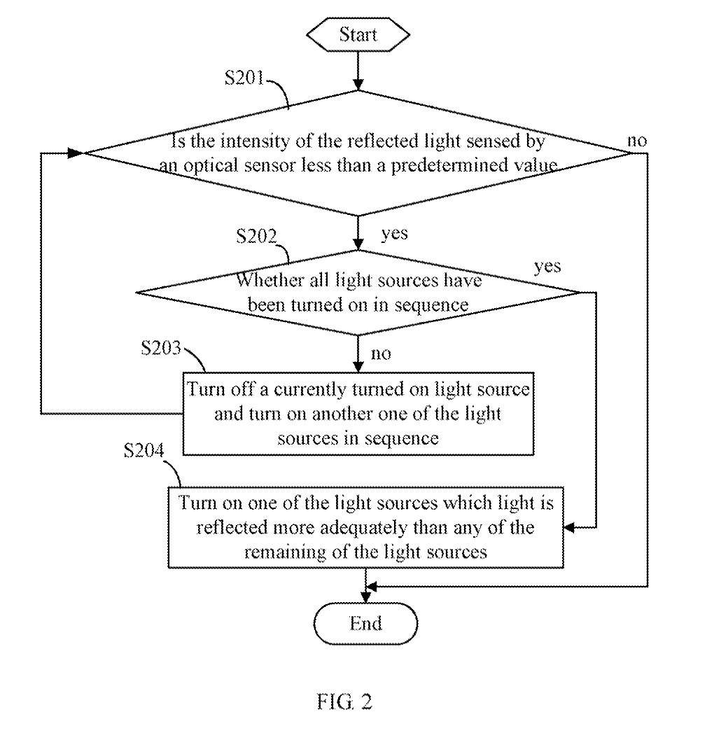

FIG. 2 is a flowchart of a light source switching method in accordance with an exemplary embodiment.

In step S201, the controller 20 determines whether the intensity of the reflected light sensed by the optical sensor 10 is less than the predetermined value. If yes, step S202 is executed, otherwise, the procedure ends.

In step S202, the controller 20 determines whether all of the light sources 40 have been turned on in sequence. If no, step S203 is executed, otherwise, step S204 is executed.

In step S203, the controller 20 directs the light source switching module 30 to turn off the currently turned on light source 40 and turn on another one of the light source 40 in sequence, and then step S201 is executed.

In step S204, the controller 20 directs the light source switching module 30 to turn on one of the light sources 40 which light is reflected more adequately than any of the remaining of the light sources 40.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. An optical mouse comprising:
an optical sensor;
at least two different light sources;
a light source switching module to selectively turn on or turn off the at least two different light sources; and
a controller to determine the intensity of the reflected light sensed by the optical sensor when any one of the at least two different light sources is turned on, and further to turn off a currently turned on light source and direct the light source switching module to turn off another one of the at least two light sources in sequence if the intensity of the reflected light sensed by the optical sensor is less than a predetermined value.

2. The optical mouse as described in claim 1, wherein if the controller determines that the intensity of the reflected light sensed by the optical sensor is less than the predetermined value when all of the at least two different light sources have been turned on in sequence, the controller is to direct the light source switching module to turn on one of the at least two different light sources which light is reflected more adequately than any of the remaining of the at least two different light sources.

3. The optical mouse as described in claim 1, wherein the at least two different light sources emit visible light with different wavelength.

4. The optical mouse as described in claim 1, wherein one of the at least two different light sources emits infrared, and the remaining of the at least two different light sources emit visible light with different wavelength.

5. A light source switching method applied in an optical mouse, the optical mouse comprising an optical sensor and at least two different light sources, the light source switch method comprising:
determining whether the intensity of the reflected light sensed by the optical sensor is less than a predetermined value when any one of the at least two different light sources is turned on; and
turning off a currently turned on light source and turning on another one of the at least two different light sources in sequence if the intensity of the reflected light sensed by the optical sensor is less than the predetermined value.

6. The light source switching method as described in claim 5, further comprising:
turning on one of the at least two different light sources which light is reflected more adequately than any of the remaining of the at least two different light sources if the intensity of the reflected light sensed by the optical sensor is less than the predetermined value when all of the at least two light sources have been turned on in sequence.
